(19) United States
(12) Patent Application Publication
(10) Pub. No.: US 2001/0036865 A1
(43) Pub. Date: Nov. 1, 2001

(54) Interactive game system

(76) Inventor: Paul B. Neal III, Burke, VA (US)

Correspondence Address: Paul B. Neal III, 6700 Wooden Spoke Road, Burke, VA, 22015, US

(21) Appl. No.: 09/770,309

(22) Filed: Jan. 29, 2001

Related U.S. Application Data
(60) Provisional application No. 60/182,053, filed on Feb. 11, 2000.

(51) Int. Cl. G06F 17/00

(52) U.S. Cl. 463/42

(57) ABSTRACT

An interactive game system for individual participants at remote locations to compete with one another over a distributed electronic network in response to a game show host administering a program broadcast via mass media. Participants are authenticated in order to participate in the game. A computational center evaluates the correctness and speed of responses made by participants, administers a scheme for rating the performance of each participant in real time, and reports back the results of this performance evaluation. In the preferred embodiment, the game is divided into a discrete plurality of rounds. Successful participants in each round advance to subsequent rounds until a champion is determined. The game then begins anew.

### CROSS-REFERENCE TO RELATED APPLICATIONS

This application claims the benefit of U.S. Provisional patent application Ser. No. 60/182,053, filed Feb. 11, 2000 for a TELEVISION GAME SHOW.

### DESCRIPTION BACKGROUND OF THE INVENTION

1. Field of the Invention

The present invention generally relates to interactive game systems. More specifically, the present invention relates to games played over a distributed computer network by individual participants interacting with a game show host broadcast via mass media in real time wherein the individual participants compete with one another as a part of the game.

2. Description of Related Art

Interactive systems wherein individuals respond to a broadcast signal have been generally known in the art for many years. For Example, U.S. Pat. No. 3,789,136, issued to Haith et al. On Jan. 29, 1974, describes an electronic system whereby television viewers may interact with a broadcast television signal for educational purposes. However, the system described by Haith et al. '136 does not involve a competitive game. Thus, the individual users of the interactive system described by Haith et al. '136 are not networked with one another.

U.S. Pat. No. 4,745,468, issued to Von Kohorn on May 17, 1988, describes an interactive system wherein an evaluation is made as to the correctness and speed of responses made by a plurality of individuals at remote locations in response to broadcast transmissions, including game show quiz questions. The system described by Von Kohorn '468 also includes a scheme for scoring and comparing the competitive performance of individual participants in the interactive game system. However, the system disclosed by Von Kohorn '468 does not allow for a comparison of the performance of its interactive participants in real time because its participants are not networked with one another.

U.S. Pat. No. 5,073,931, issued to Audebert et al. on Dec. 17, 1991 seeks to improve on the timing circuitry of Von Kohorn '468 to prevent cheating after the time of the broadcast transmission. However, the interactive system described by Audebert et al. '931 does not accomplish this improvement by networking individual participants in the system with one another.

Similarly, U.S. Pat. No. 5,850,447, issued to Peyret on Dec. 15, 1998, also describes an interactive game system designed to prevent fraud by individual participants. The system of Peyret '447 utilizes a central processing unit to verify the chronology of responses by remote participants in an interactive game system. However, the system of Peyret '447 does not verify responses in real time. Thus, there is a need for an interactive game system wherein a plurality of individual participants are connected by a computer network to a central processor capable of evaluating responses of the participants for correctness and timeliness and of comparing the performance of individual participants in real time.

Other related patents include U.S. Pat. No. 5,841,980, issued to Waters et al. on Nov. 24, 1998; U.S. Pat. No. 5,860,862, issued to Junkin on Jan. 19, 1999; U.S. Pat. No. 5,890,963, issued to Yen on Apr. 6, 1999; U.S. Pat. No. 5,964,660, issued to James et al. on Oct. 12, 1999; and U.S. Pat. No. 6,012,984, issued to Roseman on Jan. 11, 2000.

Waters '980 describes a system for communication networks in multi-user applications. The system disclosed by Waters '980 is designed to overcome bandwidth limitations and thus facilitate large scale national participation in multiple user applications over a computer network. When used in connection with a computer network as in Waters '980 for example, it is commonly understood that an ‘application’ refers to server-side software components. Though it describes the use of such an application, the system disclosed by Waters '980 is not related to interactive game systems played over a distributed computer network by individual participants interacting with a game show host broadcast via mass media.

Junkin '862 describes an interactive system wherein individual participants compete in an interactive game based on an event occurring in real time such as a sporting event. However, the system described by Junkin '862 does not involve responses by the individual participants in reaction to the broadcast real time event. Thus, the system described by Junkin '862 does not relate to a broadcast media game show involving interactive responses to quiz questions or the like.

Yen '963 discloses a system for maintaining continuous and progressive game play in a computer network. James et al. '660 also discloses a networked multi-player game. However, the games described by Yen '963 and James et al. '660 are computer games designed for use by and between interactive computer users. Thus, the games described by Yen '963 and James et al. '660 do not relate to interactive game systems incorporating broadcast media or interaction with a game show host in a broadcast studio.

Similarly, Roseman '984 describes a system for providing large arena games over computer networks. However, the system of Roseman '984 is directed primarily toward board games such as bingo and a method for generating images of game boards for such games over the Internet. Thus, the system of Roseman '984 is not related to interactive game systems incorporating broadcast media.

U.S. Pat. No. 5,916,024, issued to Von Kohorn on Jun. 29, 1999, and U.S. Pat. No. 5,936,661, issued to Trew on Aug. 10, 1999 describe interactive television game show systems wherein viewers provide responses by telephone to game show quiz questions broadcast from a television studio. Von Kohorn '024 also describes the use of interactive two-way cable as an alternative to broadcast television. However, Von Kohorn '024 and Trew '661 do not describe the use of the Internet to link individual participants in the game show by a computer network.

When playing a competitive interactive game show wherein participants respond to quiz questions on a large scale, it is desirable to have a predetermined scheme by which performance is evaluated. For example, it is desirable to designate a winner or group of winners, a ranking of individual participants among the field of all participants, or the like. One such scheme involves a plurality of rounds of play wherein successful participants from prior rounds advance to subsequent rounds and the number of participants is reduced in each succeeding round of play. None of the foregoing U.S. Patents disclose an interactive game system wherein contestants who respond correctly to a certain number of questions within a certain time limit advance to ensuing rounds of competition during which the number of contestants is sequentially reduced. Thus, there is a need for such an interactive game system.

When playing a competitive interactive game show wherein a large number of participants respond to quiz questions, it may also be desirable to group the larger pool of participants into smaller groups so as to limit the number of competitors facing each individual participant. In other words, it is desirable to have an interactive game system with the ability to establish both localized groups and aggregated groups. None of the foregoing U.S. Patents disclose an interactive game system wherein participants compete in smaller groups. Thus, there is a need for an interactive game system that has the ability to create smaller groups of competitors facing each participant, the ability to establish both localized groups and aggregated groups.

One way to accomplish this desire is to group participants according to geographic region or other characteristic such as Internet service provider. None of the foregoing U.S. Patents disclose an interactive game system wherein participants compete within discrete groups based on geographic location or other characteristic. Thus, there is a need for an interactive game system wherein participants are grouped according to geographic location or other characteristic.

With the advent of the Internet into common everyday life in recent years, competition among companies that make and sell the client-side software components known as web browsers has been tremendous. Furthermore, a software application of some sort is generally necessary to play an interactive game over the Internet. Thus, when playing an interactive game over the Internet, it may be desirable to utilize a specific proprietary web browser or non-proprietary web browser. None of the foregoing references describe the use of a specific proprietary or non-proprietary web browser in connection with an interactive game system. Thus, there is a need for a specific proprietary or non-proprietary web browser for use in connection with an interactive game system.

A session is an interaction wherein an electronic signal is transmitted from one computer terminal to another and then back thus establishing a collaborative exchange of information and binding the components of a particular computer to a computer server. Even more recently than the advent of the Internet into everyday life, consumers have begun to use a variety of electronic devices, other than a personal computer, to which a session is established via the Internet. For example, products are now commercially available whereby a session is established via the Internet to a hand held apparatus, a telephonic apparatus with a visual display, and many other types of electronic devices developed more recently than the typical desk-top or lap-top personal computer with modem.

It is anticipated that the use of such devices will become widespread in the near future. However, none of the foregoing references describe the establishment of a session via the Internet to a hand-held, telephonic, or other portable electronic apparatus in connection with an interactive game system. Thus, there is a need for an interactive game system wherein a session is established via the Internet to a hand-held, telephonic, or other portable electronic apparatus.

It is anticipated that, in the future, other forms of electronic networks may be developed or existing alternatives may begin to be used to supplement the electronic traffic almost exclusively limited to the Internet at this time. For example, high bandwidth networks are currently available as an alternative means of connecting with the Internet, and will most likely continue to grow as a substitute means of connecting with the Internet in the future.

Similarly, the use of ATM networks may grow and such networks may increasingly be used as a parallel electronic network in the future. Likewise, Frame Relay, Digital Subscriber Line (‘DSL’), cable television, and Sonet networks may, in the future, see entry into, or expansion of use within, the field of parallel electronic networks.

None of the foregoing references describe the transmission of a signal via an alternative electronic network connection to the Internet in association with an interactive game system. Thus, there is a need for an interactive game system wherein a session is established via an alternative electronic network connection to the Internet.

In all of the above described applications, it may also be desirable to authenticate authorized participants. Similarly, in all of the above described applications, it may be be desirable for interactive game players to authenticate the computer server to which they will be sending responses.

None of the foregoing references describe a means of authenticating authorized participants or computer servers in connection with an interactive game system. Thus, there is a need for an interactive game system wherein participants and computer servers can be authenticated.

Piracy is another problem that has accompanied the advent of the Internet into everyday life in recent years. It has become commonplace to hear of cases where hackers or other criminally minded computer experts have stolen confidential personal information from Internet users.

Thus, there is a need for some form of security such as encryption in connection with a web browser used to play an interactive game over the Internet. None of the foregoing U.S. Patent references describe the use of encrypted security in connection with a web browser used to play an interactive game over the Internet.

### SUMMARY OF THE INVENTION

It is therefore an object of the present invention to provide an interactive system wherein a plurality of individuals respond to a broadcast signal.

It is also an object of the present invention to provide an interactive system wherein a plurality of individuals are networked with one another.

Another object of the present invention is to provide an interactive system wherein an evaluation is made in real time as to the validity, correctness and speed of responses made by a plurality of individuals at remote locations in response to broadcast transmissions including game show quiz questions.

A related object of the present invention is to compare the competitive performance of a plurality of individuals participating in an interactive game in real time.

Still another object of the present invention is to provide an interactive system wherein large scale national participation in response to a broadcast game show is achieved over the Internet.

A further object of the present invention is to provide an interactive game system with a predetermined scheme by which performance is evaluated and tabulated results rating individual participants in the game with respect to other participants in the game are presented.

Yet another object of the present invention is to provide an interactive game system with a plurality of discrete rounds of competition.

A related object of the present invention is to utilize a pyramid scheme of advancement whereby the number of participants in each round of play following an initial round of play is reduced until a single winner or predetermined number of winners are designated, and then repeating this scheme anew.

A still further object of the present invention is to group the entire field of participants in an interactive game system into smaller pools of participants during various phases of the game.

A yet still further related object of the present invention is to group participants from the entire field of an interactive game system into smaller sets according to geographic region or other logical characteristic or random assignment.

Another object of the present invention is to provide a system for playing an interactive game over the Internet with a specific, proprietary or non-proprietary web browser.

Still another object of the present invention is to provide a system for playing an interactive game over the Internet wherein a session is established via the Internet to a hand-held, telephonic, or other portable electronic device.

Another related object of the present invention is to provide a system for playing an interactive game over the Internet wherein information transferred, and any related applications, are encrypted or otherwise secured against piracy, theft, or other unauthorized access.

Yet still another object of the present invention is to provide a system for playing an interactive game over the Internet whereby authorized individual participants are authenticated by the system prior to approval for the participant to join in the game, or a computer server is authenticated by the participants prior to submission of responses in connection with the game, or both.

An object of the present invention related to the foregoing is to provide a continuous interactive gaming system whereby a prospective participant may join the game at any time.

A final object of the present invention is to provide a system for playing an interactive game incorporating any combination of the foregoing objects wherein a session is established via an electronic network other than exclusively the Internet.

In order to accomplish these and other objects of the invention, an interactive game system is provided for a large number of individual participants at remote locations to compete with one another over a distributed electronic network such as the Internet in response to a game show host administering a program that is broadcast via mass media. A specific proprietary or non-proprietary web browser is used to participate in one embodiment of the game. All information transferred during the game, and applications related to the game, are securely encrypted so as to prevent piracy, theft and unauthorized access.

Participants are authenticated by the system prior to approval to participate in the game. Similarly, participants may authenticate the computer server to which they will submit their responses prior to the beginning of the game.

A powerful computational center or network of computational centers such as a server cluster or group of server clusters evaluates the correctness and speed of responses made by a large field of participants in the game. This computational center or group of computational centers administers a scheme for scoring or otherwise comparing or rating the performance of each individual participant relative to the entire field of participants, or relative to a predetermined subgroup of participants or performance standard, in real time, and reports back the results of this performance evaluation.

In one embodiment, the game is divided into a discrete plurality of rounds. Successful participants in each round advance to subsequent rounds and unsuccessful participants in each round are eliminated from the competition. Thus, the number of participants in each subsequent round grows smaller than the number of participants in the previous round until a single champion is determined at the end of a final round. The game then begins anew.

In the preferred embodiment, the participants are also grouped according to geographic region or other characteristic. Each participant competes only against those participants within his or her designated group. In ensuing rounds, when the number of participants is reduced, the size of each grouping characteristic is increased so as to combine participants not previously grouped together. In the final round, all remaining participants are grouped together irrespective of the previously applied grouping characteristic. Put differently, the winners of each preceding group represent that group against the winners of other groups in subsequent rounds.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of an exemplary interactive game system according to the present invention;

FIG. 2 is a flow diagram further showing a round according to the exemplary interactive game system shown in FIG. 1; and

FIG. 3 is a flow diagram of an exemplary advancement scheme according to the exemplary interactive game system shown in FIG. 1.

Similar reference characters denote corresponding features consistently throughout the attached drawings.

### DETAILED DESCRIPTION OF A PREFERRED EMBODIMENT OF THE INVENTION

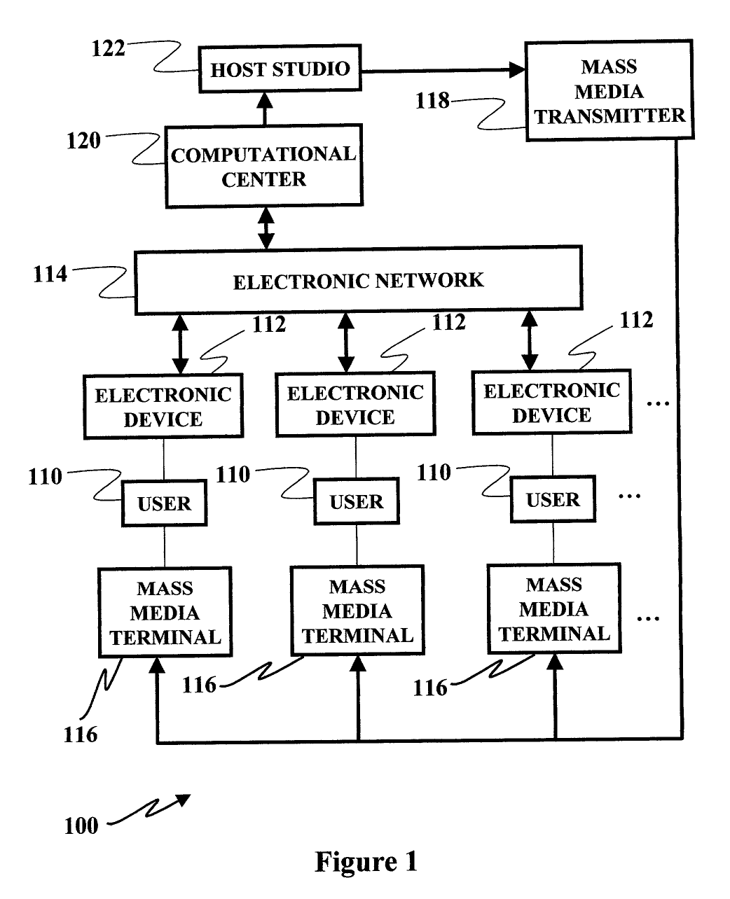

Referring now to FIG. 1, there is shown, in block diagram form, an exemplary embodiment of an interactive game system 100 according to the present invention. The directional arrows in FIG. 1 indicate a flow direction of an electronic signal or other coding of electronic information. Some of the directional arrows in FIG. 1 are big-directional. Some are not. Bi-directional arrows indicate a two-way flow of information. The other arrows indicate a one-way flow of information. And, the other lines connecting the various elements depicted in FIG. 1 represent an environmental proximity.

A plurality of users 110 exist at various locations. Each user 110 has an electronic device 112 that is connected to an electronic network 114. The electronic network 114 is fully integrated and has communication capability. In the preferred embodiment, the users 110 are participants in a competitive endeavor such as a game show or contest.

The preferred electronic device 112 is that device which is the most common means for interacting with the electronic network 114. At present, the preferred electronic device 112 is a personal computer. As technological conventions advance, the preferred electronic device 112 may change to a hand held apparatus, a telephonic apparatus with a digital-to-analog converter or some other display means, or some other electronic device currently available or yet to be developed that may acquire widespread use.

The users 110 have access to a mass media terminal 116. The mass media terminal 116 is capable of receiving and reproducing a program broadcast from a mass media transmitter 118. The program is broadcast via some form of mass media. Since television is currently the most widely disseminated form of mass visual broadcast media, the preferred broadcast program is a television program and the mass media terminal 116 is a television or a computer monitor capable of receiving and reproducing the television broadcast.

In alternative embodiments, the program is broadcast by radio or some other form of mass media such as a satellite transmission. In yet another alternative embodiment, the program is simulcast in two or more forms of mass media. For example, the audio signal from a television program is simultaneously transmitted as a radio signal.

It is expected that interactive and broadcast television will become widely available on the Internet in the coming years. Some experts believe that, within the foreseeable future, television signals will no longer be broadcast through the air. If and when this occurs, the mass media programs available on the largest scale may be programs broadcast over the Internet via DSL, ISDN, television cable access or the like. This may be desirable because, for example, DSL lines have a higher bandwidth than other means of connecting to the Internet. Thus, in some embodiments, the mass media terminal 116 and the electronic device 112 are one and the same apparatus performing at least two different functions simultaneously.

The interactive game system 100 of the present invention is designed in a manner that it is able to be implemented on a massive scale. Thus, it is anticipated that the interactive game system 100, described herein, could be implemented throughout an entire nation. For example, it is anticipated that the game show program will be broadcast by way of a major television network of affiliates, such as those major networks known by the symbols ‘NBC’, ‘ABC’, ‘CBS’, ‘FOX’, ‘WB’, ‘TNT’ or ‘UPN’, capable of reaching nearly all geographical areas of the United States.

Alternatively, it is anticipated that the game show program will be broadcast on one of a multitude of cable television stations carried by all of the major cable television service providers in the United States. Thus, it is preferred that the electronic network 114 of the present invention be an integrated network reaching the largest number of possible users 110. Currently, that integrated network is the Internet.

In order to reach the broadest, largest, and most diverse audience possible, the game show of the present invention is simultaneously broadcast in more than one language. Alternatively, the game show program is broadcast with secondary audio channels in different languages. It is anticipated that broadcast Internet television will someday be widely available throughout the world. Thus, it is conceivable that the interactive game system of the present invention could be implemented on a global scale.

At an opposite extreme, the interactive game system described herein can be implemented for use by a single user 110. For example, the interactive game system may be used to administer a test to a user 110 who is a student. Also, the interactive game system may be used to expose the user 110 to an educational program. In this last example, the user 110 interacts with the program content to learn about subjects that the user 110 finds more interesting.

The electronic network 114 is connected to a computational center 120 at a processing site, or to a network of computational centers 120 at a plurality of processing sites. If possible, it is preferred that the computational center 120 is a single central processing unit (hereinafter “CPU”). However, the memory or processing power necessary to operate the game may exceed the available memory or processing capability of a single CPU. Thus, a plurality of CPUs at various processing sites may be linked to accomplish the functions of the present invention as if they were a single CPU. This linkage of the CPUs may be conducted over a high bandwidth network such as the Frame Relay, Sonet, or ATM networks, or over another network having superior performance relative to the available alternatives.

Thus, if a plurality of CPUs are linked to accomplish the functions of the present invention, this link is not necessarily formed over the Internet. However, for at least a short time into the future, if not longer, it is preferred that the Internet be used to link CPUs in the embodiment of the present invention where a plurality of CPUs are linked.

The computational center 120 is linked to a host studio 122. The host studio 122, in turn, is linked to the mass media transmitter 118. In the preferred embodiment of the present invention, the broadcast program is a game show and the users 110 are contestants in the game. In this preferred embodiment, a game show host is in the host studio 122.

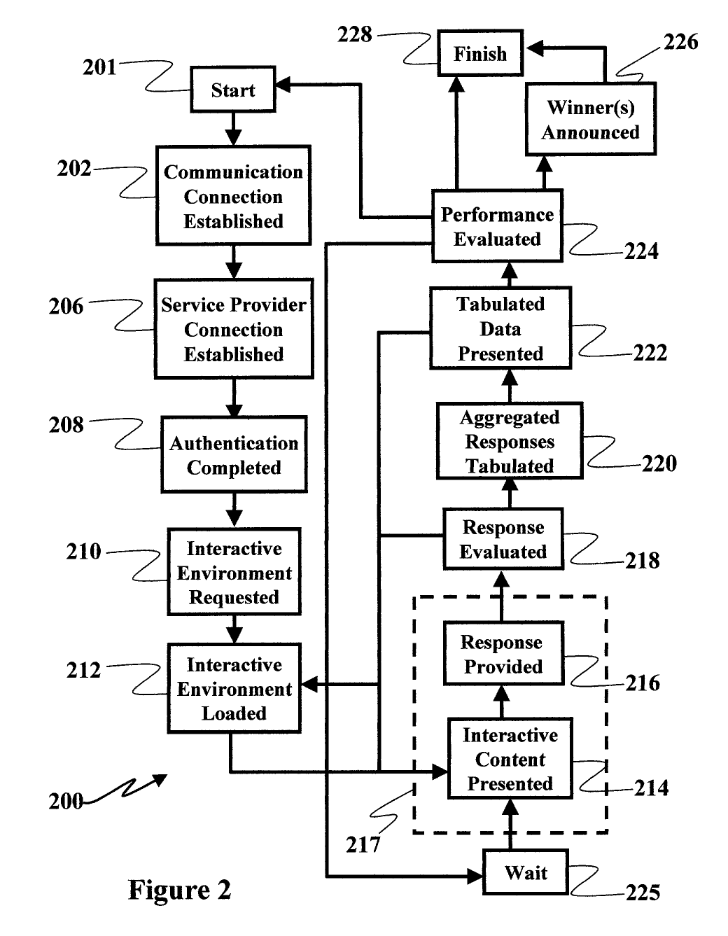

Referring now to FIG. 2, there is shown a flow diagram of a round 200 according to the exemplary interactive game system 100 of the present invention. In step 202, the first of these exemplary steps, the user 110 establishes a communication connection between the electronic device 112 and a communication link. Today, the preferred communication link in step 202 is a telephone line.

In step 206, the communication connection previously established reaches an electronic network service provider. The electronic network service provider completes the connection of the electronic device 112 with the electronic network 114.

In the preferred embodiment, the electronic network service provider is an Internet service provider (ISP). This is preferred because the Internet is currently the most widely used electronic network 114. It is conceivable that, at some time in the future, another type of electronic network 114 will replace the Internet as the most widely use electronic network 114. Thus, it is not essential to the present invention that the electronic network 114 be the Internet.

Navigating the Internet requires a client-side software component currently known as a web browser. In order to implement the interactive game system 100 of the present invention, the web browser utilized by the users 110 requires a server-side software component capable of implementing the game in collaboration with that web browser. This client-side and server-side software, working in collaboration, will control the various features of the game show such as the mode of responding to questions, the timing circuitry, the interactive environment, and information used to create characteristic groupings of users 110 or determine advancement.

Currently strong competition exists among and between the corporations that develop and sell web browsers. The application software necessary to implement the game show of the present invention in collaboration with a particular web browser will make that web browser more attractive to web browser users and consumers of web browser software applications. Furthermore, a collaboration between a developer and seller of web browsers may be desired.

Consequently, one embodiment of the present invention includes a server-side application component that can only be used in connection with one specific brand of web browser, one specific client-side software component; that is, a proprietary web browser. In this embodiment, only one maker and seller of web browsers will be able to include the proprietary web browser capability of the present invention as a component of its web browser. And, only consumers of that web browser will be able to participate as users 110 in the interactive game system 100.

Strong competition also currently exists among and between the entities that provide Internet service, the ISPs. The inclusion of a proprietary component that uniquely gives the web browser of the present invention the capability to participate in an interactive game system will make that web browser more attractive to web browser users and consumers of web browser software.

Thus, an incentive exists for ISPs to provide Internet service in connection with a web browser containing a proprietary web browser capability. Therefore, a collaboration may be desired between a particular ISP and the developer and seller of a web browser that includes the proprietary web browser capability of this embodiment of the invention.

Consequently, it may be desired that the web browser of the present invention work in connection with only one specific ISP, that is, a proprietary Internet service provider. Only one ISP will operate using the web browser that includes the proprietary web browser capability of this embodiment. In combination, a proprietary web browser and a proprietary ISP control and limit access to the computational center 120 and to the functions performed by the computational center 120.

However, a collaboration may not be desired between the entity that develops the software application and any single company that develops the web browser. In that case, the software application will be designed to function with more than one web browser company. Thus, in that case, the various web browsers implementing the software application of the present invention will be non-proprietary web browsers.

Similarly, a collaboration with a particular Internet service provider may not be desired. In that case, the ISPs used for the present invention are non-proprietary ISPs.

Note also that a user 110 who accesses a web browser according to the foregoing description is known as a “thin client”. The thin client is designed to have a smaller amount of code in the layer of code known as the presentation layer.

An alternative to a thin client is referred to, predictably, as a “fat client”. A fat client has a large amount of code in the presentation layer relative to a thin client. For a fat client, the software located on the server instead of the client-side software typifying a web browser.

A disadvantage of the fat client is that any change to the software would require each and every user 110 to access and incorporate that change. Therefore, it is preferred that the user 110 is a thin client utilizing a web browser as describe herein. Nevertheless, in an alternative embodiment of the present invention, the user 110 is a fat client.

In the next step of the preferred embodiment, step 208, authorized individual users 110 are authenticated by the electronic network 114 or the computational center 120 prior to approval for the user 110 to continue. In the absence of a step 208 for authenticating a user 110, a single person could participate as multiple users 110. Likewise, an incentive may exist to falsify the identity of a user 110 who wins a valuable prize in connection with the interactive game system 110. Thus, the possibility of unfair competition, cheating and fraud exist. Therefore, it is desirable to have an authentication step 208 wherein the identity of a user 110 is confirmed.

Several different embodiments of step 208 are possible. Hardware may be utilized to perform the authentication process in at least two different embodiments. For example, in one embodiment of the authentication process utilizing hardware, a chip may be embedded in the electronic device 112 to ensure that the user 110 is authentic in step 208 by generating an authentication code.

However, the hardware chip approach to step 208 may be overcome with software technology or network detection technology in other embodiments. Also, if the step of authentication 208 is accomplished using a hardware chip, it may be more difficult to implement new technology or other changes in the authentication step 208. Thus, the hardware chip approach to step 208 is not preferred.

Alternatively, another embodiment of the authentication process in step 208 utilizing hardware incorporates an external token that generates a portion of the information necessary to authenticate the user 110. The token is a self-contained hardware item. Preferably, the token is small. For example, a preferred embodiment of the token conforms roughly to the size and shape of a common plastic credit card. Thus, the preferred token may be stored in a wallet or a purse.

In another embodiment, the token is a removable card such as a PCMCIA card. In this embodiment, the token is removably connected to the electronic device 112. The token is provided to those users 110 who are authorized to participate in the interactive game system 100. The token supplied to each user 110 has a code or algorithm unique to that token to identify the user 110 and authenticate the identity of the user 110.

In the embodiments of step 208 utilizing a token, the ISP or server issues a code containing understandable information. The user 110 enters that information on the token. In response to the information entered by the user 110, the token issues a reply also consisting of understandable information. The user 110 enters the reply generated by the token on the electronic device 112. The ISP or server evaluates the information entered by the user 110 and determines if it is correct. If the ISP or server determines that the information entered by the user 110 on the electronic device is correct, then the ISP or server authenticates that user 110 to complete the embodiment of step 208 incorporating a hardware token.

For embodiments of step 208 having a token removably connected to the electronic device 112, the user 110 installs or attaches the token to the electronic device 112 in an appropriate manner. Otherwise, the actions performed by the user 110 in step 208 as described above are automated in embodiments of step 208 having a token removably connected to the electronic device 112.

Other embodiments of step 208 utilize software rather than hardware. For example, in one embodiment of step 208, the ISP includes an authentication and encryption software package component. In this embodiment, the electronic device 112 includes sufficient electronic information to have a shared secret with the ISP. Also, the authentication and encryption package is designed so as to authenticate the ISP on which the application is being used and prevent the application from being installed or used in connection with an unauthorized ISP.

However, ISP encryption is sometimes limited in scope. Therefore, it is not preferred to accomplish step 208 by means of an authentication package included as an integral component of an ISP.

In a variation applicable to all of the previously described embodiments of step 208, the user 110 is authenticated by simply using a password including a log on password, a security code, a personal identification number, or another identification unique to that user 110. When a security code such as a personal identification number is assigned to a user 110 authorized to participate, the user 110 provides that security code to the electronic network service provider after establishing a connection in step 206.

This variation may achieve limited success in preventing third parties from falsifying the identity of the user 110. However, this approach will not prevent forms of cheating wherein a single user 110 adopts a plurality of aliases or false identities or the token belonging to a user 110 is misplaced or stolen. Therefore, this variation to step 208 is not preferred.

In yet still another embodiment of step 208, the ISP uses a dynamic assignment of an IP address to a user 110 over the Internet. In this embodiment, the ISP has a means to capture, store and recall the history of the IP addresses issued to the user 110.

One example of such a means is the dynamic assignment convention known as Dynamic Host Configuration Protocol (‘DHCP’), wherein the ISP dynamically selects an IP address from its block and assigns that address to the user 110. In this example, the ISP's authentication method in step 208 is the only element necessary to establish non-repudiation of the user 110 participating in the interactive game system 100.

In this embodiment, the access granted to the user 110 is controlled by software at the ISP. The software provides a historical log of the connections by the user 110 between the computational center 120 and the ISP that tracks the individual assignment of the IP address to the user 110. Information concerning the connection between the ISP and the computational center 120 is kept in a database. The database is protected to prevent tampering.

The foregoing embodiment of step 208 offers a greater modicum of security than the other embodiments described. Furthermore, the foregoing embodiment offers the flexibility of implementing a change to the specific means by which the identity of a user 208 is authenticated in a central location.

In fact, in an embodiment of step 208 wherein the ISP controls the authentication of the identity of a user 110, the means by which this authentication is achieved may be changed without any imposition whatsoever on a user 110. Furthermore, in this embodiment, it is possible to implement a change in the means by which authentication occurs without the user 110 having any knowledge of that change. Therefore, it is preferred that the ISP control the authentication process in step 208.

In summary, there are several means of ensuring that the user 110 is authentic, that is, the correct participant, in step 208. One means is the use of a hardware chip that has a predefined authentication method. Another employs a security token. Still another means of ensuring that the user 110 is authentic in step 208 is the use of an authentication method incorporating the log-in capability of an ISP in which the ISP performs the function of authentication management.

Yet still another means of authenticating the user 110 in step 208 is through the capture and use of IP information and tracking the assignments of IP addresses through the capture of a historical table of dynamic IPs assigned to individual users 110. The IP tracking and capture information is stored in a database.

In addition to the incentives previously discussed for falsifying the identity of a user 110, an incentive may also exist for ISPs to counterfeit an authorized ISP. For example, a competitor of the authorized ISP may seek to draw users 110 away from the authorized ISP so as to limit competition. Therefore, in another embodiment of step 208, the electronic network service provider is also authenticated by the user 110. This can be accomplished using Secure Socket Layer (SSL) technology or the like.

After authentication has been successfully completed in step 208, in the next step, step 210, the user 110 requests an interactive environment with the electronic device 112. In the preferred embodiment, step 210 consists of requesting the content of a uniform resource locator (URL) address assigned to an interactive game page on the Internet.

Once the interactive environment has been requested, in the next step, step 212, an application service provider (ASP) downloads the interactive environment to the electronic device 112 of each authenticated user 110 who has connected to the URL of the ASP.

In the preferred embodiment, the interactive environment consists of an Internet web page for a game show, including plug-ins such as radial buttons, arrows, check boxes, fill-in blanks, dialog boxes, drop down menus, and/or “Active X Controls,” as they are known, or enterprise Java beans (EJBs), applets, or the like. These plug-ins and Active X Controls are navigation and response entry control mechanisms associated with pieces of information related to the interactive game system 100. They will be discussed in greater detail in connection with subsequent steps of the method of the present invention.

At this point in the round 200, each user 110 is ready to begin participating in the interactive game system 100. Naturally, it is preferred that every user 110 who wishes to participate in the interactive game system 100 complete steps 206 to 212 prior to the beginning of the broadcast. However, it is also possible that a user 110 could complete steps 206 to 212 after the beginning of the broadcast.

In the next step of the present invention, step 214, substantive content is presented to the users 110 on the mass media terminal 116 by way of the mass media transmitter 118. In this step 214, there are a number of formats the substantive content may take.

For example, the substantive content may be presented orally by a human host, or visually on a monitor, or both. The substantive content may be a video clip, an audio clip, mere words or text, or some combination thereof. In the preferred embodiment of step 214, the substantive content is a quiz question of some form or description delivered as part of an interactive game by a game show host.

In step 216, after the substantive content is presented, the user 110 provides a response by making an entry of some sort within the interactive environment displayed on the electronic device 112. In the preferred embodiment, the users 110 are expected to answer the quiz questions as fast as they are capable.

Several different types of question formats are anticipated for use in connection with the present invention. In the preferred embodiment, the interactive environment is an Internet web page. This web page includes plug-ins such as radial buttons, arrows, check boxes, fill-in blanks, other dialog boxes, and/or drop down menus, Active X Controls, EJBs, applets, or some other means of associating a particular response with a particular piece of information.

In the preferred embodiment of step 216, the user 110 provides an answer to a quiz question by means of these navigation and response entry control mechanisms sometimes known as widgets or control metaphors. Thus, in various embodiments, step 216 consists of clicking a radial button to select a single answer to a multiple choice or a true/false question, checking a box or a plurality of boxes, filling in a blank, or other similar response to a dialog box, and using pull-down menus to put a list of entries in a certain order.

Checking a plurality of boxes applies to the situation where a correct answer comprises more than one selection. In one form, the interactive content presented in step 214 consists of a question to which there may be no correct response, one correct response, or more than one correct response. Check boxes are used in step 216 when such a question is presented in step 214.

In combination, steps 214 and 216 comprise an interactive portion 217 of the round 200. In the case where a user 110 completes steps 206 to 212 after the first occurrence of an interactive portion 217, the tardy user 110 is ineligible for consideration with regard to all occurrences of the interactive portion 217 already completed. Nevertheless, this tardy user 110 may participate in any subsequent interactive portion 217.

It may be desirable for the electronic device 112 to navigate to and from a variety of display images during the interactive portion 217. For example, questions in different formats (e.g. “fill-in-the-blank” vs. multiple choice) may require different interactive environments. Thus, in the preferred embodiment, it is desirable to load a different web-page for different types of questions.

In the preferred embodiment, the web browser is designed to generate a persistent load to the electronic device 112 of the user 110 during the interactive portion 217. When a persistent load is generated by the web browser, the interactive environment is loaded into the permanent memory, not the temporary or cache memory, of the electronic device 112. It is believed that the performance of the system is improved under a persistent load. Additionally, a temporary loss of power will not result in a loss of memory to the user 110 when the electronic device 112 carries a persistent load.

In step 218, the computational center 120 evaluates the responses submitted by each individual user 110 for either speed or content or both. In the preferred quiz question game show embodiment of the exemplary interactive game system 100, one way to differentiate the performance of a plurality of users 110 is to evaluate the correctness of the responses provided by the users 110 in step 216. Another way to differentiate the performance of a plurality of users 110 is to evaluate the speed of the responses provided by each individual user 110 in step 216.

A form of mass media that includes a visual signal as well as an audio signal enables the broadcast program to display each question in writing in addition to presenting each question audibly in step 214. By doing so, the broadcast program enables a wider range of response times, particularly among the more talented users 110 in step 216. For example, when a quiz question is displayed visually concurrent with an oral reading of that question by a game show host, an outstanding user 110 may be able to answer the question correctly in step 216 before the oral delivery of the question in step 214 is completed.

With regard to the evaluation the computational center 120 performs in step 218 as to the speed of the response provided by the user 110 in the preferred game show embodiment of the interactive game system 100, it is not essential that the computational center 120 differentiate each individual response provided in step 216 along an entire continuum of time. Rather, at a bare minimum, the computational center 120 simply performs a determination as to whether or not the response provided by the user 110 in step 216 was provided by the user 110 before or after a predetermined time deadline for the submission of responses.

For example, the rules of the game show may allow the user 110 ten seconds to answer each question, measured from the time that the presentation of the question in step 214 is completed. With regard to the evaluation the computational center 120 performs as to the speed of the response provided by a user 110, the computational center 120 may simply determine whether or not that response was provided before or after the ten second deadline. In this embodiment of step 218 an evaluation of performance is based only on the number of questions answered correctly by the user 110 within the designated time limit.

In an embodiment of step 218 at an opposite extreme, the computational center 120 ranks every individual user 110 in an order based on the speed of the response provided by that user 110 in step 216. Still further, in this extreme embodiment of step 218, the computational center 120 also ranks every individual user 110 in an order based on the total number of questions answered correctly or the percentage of questions answered correctly. This extreme embodiment of step 218 would place the highest demands on the memory capacity and processor speed of the computational center 120. However, as will be discussed in greater detail below, this extreme embodiment of step 218 has significant advantages in connection with step 224.

In one embodiment of the present invention, step 214 follows each occurrence of step 218 until the interactive portions 217 are concluded. In this embodiment, no tabulated or aggregated data regarding performance is presented until after the completion of all iterations of the interactive portion 217. As previously mentioned, it may also be preferred that step 212 be repeated prior to each instance of step 214.

In step 220, the individual evaluations made in step 218 are tabulated in aggregate. In the preferred embodiment of the present invention, step 220 takes place once for each occurrence of steps 214 to 218. That is to say, in the preferred embodiment, aggregate data is tabulated in step 220 for each question presented in step 214 after the responses to that question are evaluated in step 218.

As previously mentioned, in an alternative embodiment of the invention, the tabulation of data in step 220 takes place only after the completion of all iterations of the interactive portion 217. However, even when step 220 occurs after each instance of steps 214 to 218, it is preferred that step 220 also take place after the conclusion of all iterations of the interactive portion 217. In fact, for most embodiments of step 224, discussed within, it is necessary for aggregate data to be tabulated in step 220 not only with regard to individual occurrences of steps 214 to 218, but also with regard to the sum total of all occurrences of steps 214 to 218.

In the preferred embodiment of step 220, the computational center 120 provides the average response time to each question presented in step 214 and the proportion of users 110 who answered each question correctly in step 214. Other embodiments of step 220 will be discussed below.

Also, although preferred for simplicity when possible, it is not mandatory that the computational center 120 itself perform the tabulation of the aggregated data. Alternatively, the computational center 120 delegates the tabulation of aggregate response data in step 220 to another distinct computational entity. Should the load on the computational center 120 approach a peak capacity of the computational center 120, then that load is reduced by delegating the tabulation of data to a separate computational entity. Thus, at times of peak loads, it is preferred that a separate computational entity perform the tabulation of aggregate response data in step 220.

In step 222, the results of the tabulation performed in step 220 are presented to the user 110. In the preferred embodiment of step 222, this presentation of the tabulated data is performed in two different ways. First, a human host of the broadcast program presents the tabulated response data as a part of the broadcast program. And second, in the preferred embodiment of step 222 the tabulated data is also transmitted from the computational center 120 to the electronic device 112 of each authenticated user 110 via the integrated electronic network 114. The data presented in these two different ways may be entirely redundant, entirely unique, or partially redundant and partially unique.

Step 224, takes place after the conclusion of all iterations of the interactive portion 217. In step 224, the computational center 120 makes a determination as to which users 110 have achieved a certain threshold of performance with the responses provided in step 216, and which users 110 have not. In the preferred embodiment of the interactive game system 100, the users 110 who have surpassed the given threshold advance to a subsequent round 200 and thus return to the start 201. The users 110 who have not surpassed the given threshold will not continue and thus pass to the finish 228 of the round 200.

Also, at the conclusion of a round 200, the computational center 120 designates a single overall winner or champion in step 226. Alternatively, the computational center 120 designates several levels of winners in step 226 at the conclusion of the round 200.

In one embodiment, prizes are awarded during step 226. In the preferred embodiment, at a minimum, a single champion is awarded a prize of some sort for winning the game. Alternatively, prizes of varying degrees of value are awarded to a plurality of users 110 according to the outcome of step 224. The better the performance of the user 110, the larger the value of the prize awarded to that user 110. In yet another alternative, prizes are awarded to a group of successful users 110 at the end of each round 200.

In the preferred embodiment, sponsors of the game show pay the organization producing the game show for the privilege of advertising the goods or services of that sponsor on the show. Each round 200 of the game show is divided into a plurality of segments during which competition takes place. Advertisements of the sponsors are broadcast during breaks in between the competitive segments of the game show. Each competitive segment consists of one or more occurrence of the interactive portion 217.

In addition to giving sponsors time slots during which they broadcast advertisements, these breaks also provide the users 110 with an opportunity to relax between the competitive segments. The extent to which prizes are offered and the value of the prizes offered in connection with the game show will be a function of the revenue generated by the broadcasts.

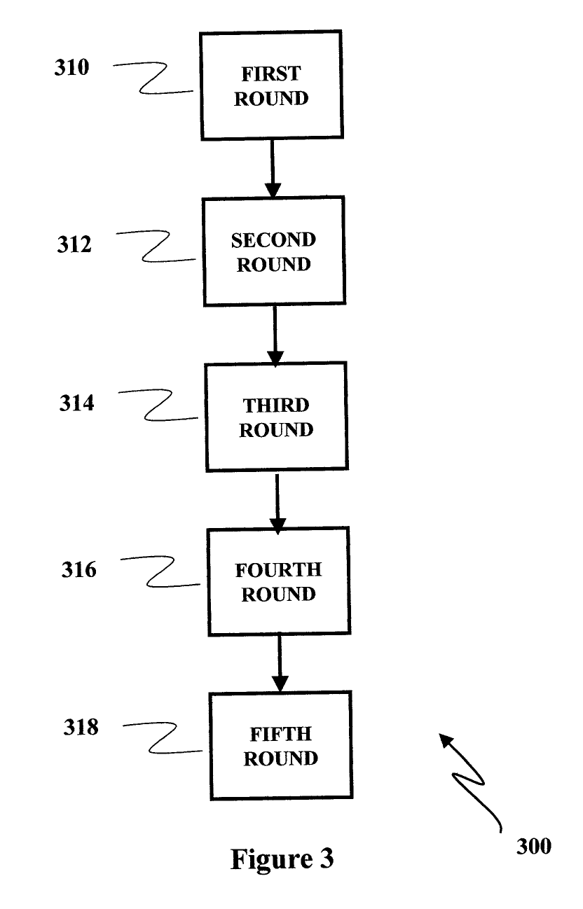

Referring now to FIG. 3, there is shown a flow diagram of an exemplary advancement scheme 300 according to the interactive game system 100 of the present invention. In the preferred embodiment of the present invention, the interactive game system 100 consists of a plurality of discrete rounds 200 beginning with a first round 310 and ending with a final round 318.

In this exemplary advancement scheme, several intermediary rounds 312-316 occur in succession after the first round 310 and prior to the final round 318. All rounds 200 prior to the final round 318 are preliminary rounds 310-316. Based upon the performance evaluation of step 224, the computational center 120 designates a pool of successful users 110 and a pool of unsuccessful users 110 in each round 200.

The exemplary advancement scheme shown in FIG. 3 consists of five rounds 310-318. However, it should be noted that alternative embodiments of the interactive game system of the present invention consist of as few as a single round or, alternatively, of any number of rounds greater than one.

The successful users 110 in the preliminary rounds 310-316 advance to compete in subsequent rounds 312-318. The unsuccessful users 110 in each preliminary round 310-316 are eliminated from further competition in the game. Thus, the total number of users 110 in each subsequent round 312-318 is smaller than the number of users 110 in the previous round 200.

The embodiment of step 218 described above that places the most taxing burden on the computational center 120 also enables a plethora of much more complicated schemes by which advancement is determined. The more complicated the scheme of advancement in step 224, the greater the benefit of an evaluation in step 218 wherein the computational center 120 ranks every user 110 in a discrete order or plurality of discrete orders.

Also in the preferred embodiment of the game of the present invention, the users 110 in the various rounds 200 are grouped according to geographic region. In alternative embodiments, the users 110 are grouped by some other characteristic, including a demographic other than geography, or randomly.

For example, in alternative embodiments, the users 110 are grouped according to time of participation, age, or affiliation with an organization such as a school, university, employer or the like. Similarly, in one embodiment, the users 110 are grouped in sequentially according to the time that each user 110 completes step 208. In another embodiment, a logical characteristic is used to form groups wherein the users 110 are combined based on their ISP. In yet another embodiment, the users 110 are grouped into smaller sets by random assignment prior to the beginning of the broadcast.

In the simplest embodiment, the computational center 120 merely lumps all users 110 together in one large aggregate group. However, although this embodiment is the simplest, it may exceed the capacity of the computational center during rounds 200 when the number of users 110 is enormous.

In the preferred embodiment, during the preliminary rounds 310-316, the users 110 compete with others in a discrete group. In one embodiment of such a discrete group, the users 110 are grouped according to the time zone wherein the electronic device 112 is located. In subsequent rounds 312-318, the successful users 110 from each group are again grouped together based on the same criteria by which they were originally grouped, but the size of the grouping characteristic is increased.

For example, in the preferred embodiment where geography is the grouping characteristic, each geographical region increases in subsequent rounds 200. Thus, in one embodiment, the users 110 are grouped by county in the first round 310. Then, in a second round 312, the users 110 are grouped by state. In a third round 314, users 110 are grouped according to a multiple state region such as the West, Midwest, South, East or the like. In the final round 318, the characteristic groupings are eliminated and all remaining users 110 are grouped together in a single aggregated field.

In one embodiment, advancement after step 224 is based on the percentage of questions answered correctly prior to a time deadline, as tabulated in step 222. In this embodiment, the software enabling the computational center 120 to complete step 218 will be the least complex. However, the number of successful users 120 will be undetermined and could vary widely from game to game and from round 200 to round 200 based on the difficulty of the questions, and from region to region based on variations in the demographics of each grouping of users 110.

For example one geographical grouping of users 110 may possess a higher mean degree of education. That grouping of users 110 will most likely have a greater success rate in achieving a static advancement threshold after step 224. Another grouping of users 110 may have, in general, a higher level of interest and involvement in a particular category of questions that may be asked by the host. Again, this grouping of users 110 will most likely have a greater success rate in achieving a static advancement threshold based solely on the percentage of questions answered correctly prior to a predetermined time deadline.

Therefore, in the preferred embodiment of step 220, the computational center 120 ranks each user 110 in each group in a numerical order based not only on the number of questions answered correctly prior to the time deadline, but also on how fast those answers were provided. In this embodiment, the number or proportion of users 110 advancing from each group after step 224 is predetermined.

However, this embodiment would require more memory and computational power from the computational center 120 and increase the complexity of the software necessary for step 218. If these added demands create difficulty in implementing the game show, then it is preferred that advancement in step 224 be based on a comparison of the performance of each individual user 110 to a predetermined threshold percentage of questions answered correctly prior to the time deadline, not a comparison of the performance of each user 110 with respect to other users 110 in a group of users 110.

In a suggested example of the foregoing advancement scheme 300, the game show consists of five rounds of play 310-318. Each round 200 is a thirty minute or a sixty minute broadcast at the same time of day on a weekday. For example, the first round 310 takes place on Monday, and the final round 318 takes place on Friday. This advancement scheme 300 is repeated anew each week. Thus, each contestant from the previous week's game may enter the following week's game. Naturally, an inconceivable number of variations are possible on this suggested scheme of advancement 300.

Referring again to FIG. 2, in one game show format according to the present invention, the game show host does not suggest any possible answers to the quiz question in step 214. For this “fill-in-the-blank” format, each user 110 must type an answer on the electronic device 112 in response to the quiz question.

For example, a fill-in-the-blank plug-in, widget, or control metaphor dialog box is provided when the interactive environment is loaded in step 212. In response to a question presented in step 214, the user 110 provides a response in step 216 by typing the response at the dialog box. Step 218 then includes a boolean search for acceptable variations in the typed response.

However, it is believed that this format would increase the complexity of a response evaluation program used by the computational center 120 in step 218. For example, if the correct answer is a thing, more than one word or name may exist that accurately identifies the thing. This would necessitate additional programming in order to provide the computational center 120 with an exhaustive Thesaurus so that the computational center 120 properly evaluates, in step 218, the correctness of a variety of responses provided in step 216.

Furthermore, the producers of the interactive game may desire that the game test knowledge but not spelling ability. In that case, the computational center 120 would be programmed so as to identify, in step 218, a wide variety of misspellings of the correct answer or various correct answers provided by the users 110 in step 216. This would add yet again to the complexity of the answer evaluation software used by the computational center 120 in step 218.

Thus, in the preferred embodiment, the content presented in step 214 includes a predetermined discrete number of suggested answers, perhaps four or five, one and only one of which is the correct answer. In this embodiment, a symbol is assigned to each of the suggested answers such as ‘a’, ‘b’, ‘c’ and ‘d’. The symbols thus assigned are symbols that correspond to an input mechanism on each electronic device 112 such as a key on the keyboard of a personal computer.

The user 110 then selects an answer to the quiz question and indicates this selection by actuating the corresponding input mechanism on the electronic device 112. For example, the user 110 types a letter on the computer keyboard associated with the response the user 110 wishes to select.

In an alternative embodiment, the user 110 activates an associated plug-in, widget, or control metaphor such as a button or an arrow loaded with the interactive environment in step 212. In yet another embodiment of this preferred “multiple choice” format, the user 110 has the option of either typing a response on a computer keyboard or selecting a plug-in, widget or control metaphor loaded with the interactive environment in step 212.

Naturally this preferred “multiple choice” format dramatically increases the likelihood that a user 110 will provide the correct response in step 216 with an uninformed guess. However, the complexity of the answer evaluation software at the computational center 120 will be dramatically reduced by the multiple choice format.

As detailed by Von Kohorn '468 and Audebert et al. '931, cheating is also a concern when dealing with interactive game systems. It is believed that the likelihood of cheating in response to a game show broadcast live during step 214 is lower than the likelihood of cheating in response to a game show that is broadcast on tape. Thus, in the preferred embodiment, the program is broadcast live.

An additional advantage to broadcasting the game show live is that a live broadcast creates the possibility for a human host to interact with the users 110. For example, as previously described, in the preferred embodiment of step 222, a human host presents the tabulated response data as a part of the broadcast program.

However, any information relayed by the host during a live broadcast could also be transmitted from the computational center to the users 110 over the electronic network 114. And, given the authentication and security safeguards of the present invention, the likelihood of cheating may be so small that any decrease in the likelihood of cheating accompanying a live broadcast may be negligible. Furthermore, since the primary duty of the host is simply to disseminate questions and, if necessary, to disseminate suggested answers to those questions, within a predetermined amount of time, a taped broadcast of the game show is also acceptable.

Naturally contestants who are not natives or residents of the United States will be at a competitive disadvantage versus those who are, if questions are asked about U.S. subjects such as History, Geography, Art, Music, Sports, etc. However, the subject of the questions asked by the game show host is not important to the present invention.

Conceivably, the demand for access to an interactive game system according to the present invention may become so pervasive as to be ever present. Thus, in one embodiment designed to satisfy an ever present demand for access to an interactive game system according to the present invention, such a game is always in progress.

In a related embodiment designed to satisfy an unsatiable demand for access to an interactive game system according to the present invention, the user 110 who wishes to continue participating does not return to the start 201 after the completion of the performance evaluation of step 224. Rather, this user 110 proceeds to a holding step 225 awaiting the commencement of an interactive portion 217 of yet another round 200. In this manner, a user who wishes to do so may complete introductory steps 201 to 212 once, and then continually participate in round 200 after round 200 for an indefinite period of time. Thus, the wait that occurs in step 225 may be infinitesimally small.

In view of the foregoing, it is seen that the described invention enables a large number of computer users at remote locations to participate over a distributed computer network in an interactive game broadcast by mass media. In one embodiment, a securely encrypted specific proprietary web browser is utilized to implement this game over the Internet and users 110 are authenticated by a hardware chip, software encryption algorithm, or other means. A large computational center or network of computational centers evaluate the correctness and speed of responses submitted by the users 110 and administer an advancement scheme based on the performance of the users 110.

Although the invention has been described in the context of an exemplary competitive game show, those of skill in the art should recognize that an alternative embodiment employs the above described invention for an educational or testing purpose rather than for entertainment. For example, in one educational embodiment of the present invention, the “game” is a non-competitive quiz employed merely as a learning tool. In another embodiment, the “game” is a test of some sort administered in connection with an educational class or any other situation where it is desired to test the user 110.

While the invention has been described in terms of a single preferred embodiment, those skilled in the art will recognize that the invention can be practiced with modification within the spirit and scope of the appended claims.

Having thus described my invention, what I claim is as follows:

1. An interactive game system for use by a user over an electronic network, the interactive game system comprising:
an electronic device in environmental proximity with said user, said electronic device connected to said electronic network;
a computational center connected to said electronic network;
a host studio for hosting an interactive program;
a mass media transmitter for transmitting a program signal of said interactive program; and
a mass media terminal in environmental proximity with said user for receiving said program signal and reproducing said interactive program.

2. The interactive game system as claimed in claim 1 wherein said computational center is connected to said host studio.

3. The interactive game system as claimed in claim 1 wherein said computational center comprises a plurality of central processing units at a plurality of processing sites in locations physically remote from said electronic device.

4. The interactive game system as claimed in claim 1 further comprising a plurality of users and wherein said interactive program is a competitive endeavor.

5. The interactive game system as claimed in claim 1 wherein said program signal is simultaneously broadcast in more than one language.

6. The interactive game system as claimed in claim 1 further comprising a plurality of mass media transmitters and wherein a plurality of program signals are simultaneously broadcast over said plurality of mass media transmitters using different mass media formats.

7. The interactive game system as claimed in claim 6 where in said different mass media formats include television, radio, and the Internet.

8. A method for playing an interactive game comprising the steps of:
establishing a communication connection between an electronic device and an electronic network;
loading an interactive environment on the electronic device;
transmitting a program signal from a mass media transmitter to a mass media terminal and presenting interactive content to a user;
said user entering a response to said interactive content on said electronic device in said interactive environment;
evaluating the response entered by the user, said step of evaluating the response being performed by a computational center;
tabulating an outcome of said step of evaluating the response;
presenting to said user a result of said step of tablulating; and
evaluating said result of said step of tabulating, said step of evaluating said result being performed by said computational center.

9. The method for playing an interactive game as claimed in claim 8 wherein the electronic network is the Internet, the communication connection is established via an Internet service provider and the interactive environment is loaded on a web-browser.

10. The method for playing an interactive game as claimed in claim 9 wherein the web-browser is a proprietary web-browser or group of proprietary web-browsers.

11. The method for playing an interactive game as claimed in claim 9 wherein the Internet service provider is a proprietary Internet service provider or group of proprietary Internet service providers.

12. The method for playing an interactive game as claimed in claim 9 wherein the interactive environment includes a persistent load.

13. The method for playing an interactive game as claimed in claim 8 further comprising the step of authenticating the user to participate on the electronic device.

14. The method for playing an interactive game as claimed in claim 13 wherein said step of authenticating is accomplished by means of a hardware authentication device.

15. The method for playing an interactive game as claimed in claim 14 wherein said hardware authentication device is an external token.

16. The method for playing an interactive game as claimed in claim 13 wherein said step of authenticating is accomplished by means of software.

17. The method for playing an interactive game as claimed in claim 13 wherein said step of authenticating requires the user to manually enter an authentication code on the electronic device.

18. The method for playing an interactive game as claimed in claim 8 wherein said communication connection is established via an electronic network service provider and further comprising the step of authenticating the electronic network service provider.

19. The method for playing an interactive game as claimed in claim 8 wherein said step of evaluating the response entered by the user includes evaluating the correctness of the response.

20. The method for playing an interactive game as claimed in claim 8 wherein said step of evaluating the response entered by the user includes evaluating the speed of the response.

21. The method for playing an interactive game as claimed in claim 8 wherein said step of presenting interactive content includes presenting said interactive content visually by written words, and audibly by spoken words.

22. The method for playing an interactive game as claimed in claim 8 wherein said step of said user entering a response is performed by a plurality of users.

23. The method for playing an interactive game as claimed in claim 22 wherein said steps of presenting interactive content, entering a response, evaluating the response, tabulating, and presenting to said user a result of said step of tablulating are repeated, and the conclusion of said repetition defines a round.

24. The method for playing an interactive game as claimed in claim 23 further comprising the step of announcing a one of said plurality of users that is a winner.

25. The method for playing an interactive game as claimed in claim 23 further comprising the step of announcing a group among said plurality of users that are successful.

26. The method for playing an interactive game as claimed in claim 25 wherein said group among said plurality of users that are successful repeat said round.

27. The method for playing an interactive game as claimed in claim 23 wherein said plurality of users are grouped into a plurality of groups based on a characteristic of each of said plurality of users and further comprising the step of announcing a set of winners within each of said plurality of groups.

28. The method for playing an interactive game as claimed in claim 27 wherein said set of winners within each of said plurality of groups repeat said round.

29. The method for playing an interactive game as claimed in claim 28 wherein said characteristic is selected from the group consisting of geographic location, time zone, age, gender, time of participation, and organizational affiliation.

30. The method for playing an interactive game as claimed in claim 23 wherein said plurality of users are randomly grouped into a plurality of groups and further comprising the step of announcing a set of winners within each of said plurality of groups.

31. The method for playing an interactive game as claimed in claim 30 wherein said set of winners within each of said plurality of groups repeat said round.

32. The method for playing an interactive game as claimed in claim 23 wherein said round is repeated continuously.

33. The method for playing an interactive game as claimed in claim 8 wherein said steps of presenting interactive content, entering a response, and evaluating the response are repeated.

34. The method for playing an interactive game as claimed in claim 8 wherein said steps of presenting interactive content, entering a response, evaluating the response, and tabulating are repeated.

35. The method for playing an interactive game as claimed in claim 8 wherein said step of tabulating is performed by said computational center.

36. The method for playing an interactive game as claimed in claim 8 wherein said step of presenting a result comprises transmitting said result from said computational center to said electronic device.

37. The method for playing an interactive game as claimed in claim 8 wherein said step of presenting a result is performed by a human host and included in said program signal.
